(19) United States
(12) Patent Application Publication
(10) Pub. No.: US 2011/0001685 A1
(43) Pub. Date: Jan. 6, 2011

(54) ANTENNA DEVICE AND METHOD FOR PRODUCING THE SAME

(75) Inventors: Shinsuke Yukimoto, Tokyo (JP); Takao Yokoshima, Tokyo (JP)

Correspondence Address: CARTER, DELUCA, FARRELL & SCHMIDT, LLP, 445 BROAD HOLLOW ROAD, SUITE 420, MELVILLE, NY, 11747, US

(73) Assignees: MITSUBISHI CABLE INDUSTRIES, LTD., Tokyo (JP); MITSUBISHI MATERIALS CORPORATION, Tokyo (JP)

(21) Appl. No.: 12/921,816

(22) PCT Filed: Feb. 24, 2009
(86) PCT No.: PCT/JP2009/000788

§ 371 Date: Sep. 10, 2010

(30) Foreign Application Priority Data
Mar. 11, 2008 (JP) 2008-061378
Sep. 26, 2008 (JP) 2008-249173

(51) Int. Cl. H01Q 1/50; H01P 11/00

(52) U.S. Cl. 343/905; 29/600

(57) ABSTRACT

An antenna apparatus includes a coaxial cable body configured by covering the peripheral portion of a core forming the power feed line with a first coating dielectric unit, a ground line and a second coating dielectric unit in that order, a main antenna element in which the core either singly or in combination with the first coating dielectric unit projects and extends from the distal end of the coaxial cable body, and an impedance adjustment element in which the ground line projects singly from the distal end of the coaxial cable body, and the impedance adjustment element maintains an orientation extending in a direction that differs from the extension direction of the main antenna element and is fixed to the distal end of the coaxial cable body.

### CROSS REFERENCE TO RELATED APPLICATIONS

The present application claims the benefit of and priority to PCT International Patent Application Serial No. PCT/JP2009/000788, filed on Feb. 24, 2009, which claims the benefit of and priority to Japanese Patent Application No. 2008-061378, filed on Mar. 11, 2008 and to Japanese Patent Application No. 2008-249173, filed on Sep. 26, 2008, each of the disclosures of which are hereby incorporated by reference in its entirety.

### TECHNICAL FIELD

The present disclosure relates to an antenna apparatus suitably applied in relation to a vehicle-mounted wireless communication technique such as a remote engine starter, a keyless operation system, a keyless entry system, or the like in an automobile, and also relates to a method of manufacturing the same.

### BACKGROUND ART

In recent years, an antenna apparatus in which an antenna element is connected to a coaxial cable has been investigated for the purpose of wireless communication including a remote engine starter, a keyless operation system, a keyless entry system, or the like for an automobile. This type of antenna apparatus has generally been configured as a monopole antenna in which a coaxial cable and an antenna element having a length of ¼ of the antenna operation wavelength are connected. However since this monopole antenna tends to be affected by the peripheral environment, such as the installation conditions, a dipole antenna is used that is not subject to environmental effects.

For example, as illustrated in Japanese Patent Application Laid-Open No. 2004-208208, the entire contents of which is hereby incorporated by reference, proposes a power feed line extraction structure including a dipole antenna in the shape of an inverted chevron connected to a ground line and a power feed line of a coaxial cable. In addition, Japanese Patent Application Laid-Open No. H09-51217, the entire contents of which is hereby incorporated by reference, proposes an automobile antenna that connects respective antenna elements to an external guide (ground line) and an internal guide (power feed line) of a coaxial cable.

However there are outstanding problems in relation to both the above conventional techniques.

More specifically, the conventional configuration generally extracts the power feed line and the ground (GND) line from the coaxial cable for connection to a separately prepared antenna element member. However the connection in this configuration between the section that extracts the power feed line or the like and the antenna element member causes an increase in the number of unstable components, and adversely affects antenna performance. More specifically, when the reflection conditions for high-frequency components or the like change in response to the state of the connection section, and the positional relationship between the connected antenna element member and the coaxial cable changes, a small degree of deterioration is caused in relation to performance. Furthermore there is a need to provide a separate antenna element, a connection operation is required, and therefore costs are increased.

The conventional technique adopts a strategy to suppress the effect of the peripheral environment and the coaxial cable by configuring the antenna element in the shape of an inverted chevron to thereby create a space. However since this strategy requires a large space, there is often a limitation on the mounting position. Furthermore the overall antenna performance may be adversely affected since the effect of the coaxial cable cannot be suppressed due to capacity coupling with the coaxial cable. Since the power feed section is central to each element of the antenna, remediation of performance is difficult in the event of deterioration in performance resulting from the effect of the peripheral environment or the like.

### SUMMARY

An antenna apparatus is provided which includes a coaxial cable body configured by covering the peripheral portion of a core forming the power feed line with a first coating dielectric unit, a ground line, and a second coating dielectric unit in that order; a main antenna element in which the core projects and extends from the distal end of the coaxial cable body; and an impedance adjustment element in which the ground line projects from the distal end of the coaxial cable body, the impedance adjustment element maintains an orientation extending in a direction that differs from the extension direction of the main antenna element and is fixed to the distal end of the coaxial cable body.

The present disclosure also provides an antenna apparatus including a coaxial cable body configured by covering the peripheral portion of a core forming the power feed line with a first coating dielectric unit, a ground line and a second coating dielectric unit in that order; a main antenna element in which the core projects and extends from the distal end of the coaxial cable body; an impedance adjustment element in which the ground line or a connection lead line connected to the ground line is folded from the distal tip of the coaxial cable body, and the impedance adjustment element maintains an orientation extending from the distal tip of the coaxial cable body along the coaxial cable body, and is fixed to the distal end of the coaxial cable body; and a tube that covers the main antenna element, the impedance adjustment element, and the distal end of the coaxial cable body, and that at least constricts the base end aperture.

A method of manufacturing an antenna apparatus is provided which includes the steps of preparing an antenna apparatus main body including a coaxial cable body configured by covering the peripheral portion of a core forming the power feed line with a first coating dielectric unit, a ground line and a second coating dielectric unit in that order, a main antenna element in which the core projects and extends from the distal end of the coaxial cable body, and an impedance adjustment element in which the ground line or a connection lead line connected to the ground line is folded from the distal tip of the coaxial cable body, the impedance adjustment element maintaining an orientation extending from the distal tip of the coaxial cable body along the coaxial cable body and fixed to the distal end of the coaxial cable body; covering the main antenna element, the impedance adjustment element and the distal end of the coaxial cable body with a heat-shrinkage tube; and heating to thereby shrink and contract the base end aperture of the heat-shrinkage tube.

### BRIEF DESCRIPTION OF THE DRAWINGS

FIG. 1 is a plan view showing an antenna apparatus according to a first embodiment of an antenna apparatus of the present disclosure;

FIG. 2 is a simplified plan view describing the dimensions and the like of the antenna apparatus according to the first embodiment;

FIG. 3 is a simplified plan view of an antenna apparatus showing a stated fixed using a tube according to the first embodiment;

FIG. 4 illustrates a conventional antenna in the shape of an inverted chevron and an ideal dipole antenna

FIG. 5 describes a configuration when the coaxial cable is bent midway (cable variation configuration) and a configuration when the coaxial cable is straight (default configuration) in a conventional example of the antenna apparatus according to the present disclosure;

FIG. 6 is a graph showing VSWR characteristics of a configuration when the coaxial cable is bent midway (cable variation configuration) and a configuration when the coaxial cable is straight (default configuration) in a conventional example of the antenna apparatus according to the present disclosure

FIG. 7 describes a configuration in which the coaxial cable is disposed in close proximity to the antenna element in a conventional example of the antenna apparatus according to the present disclosure

FIG. 8 is a graph showing VSWR characteristics of a configuration in which the coaxial cable is disposed in close proximity to the antenna element in a conventional example of the antenna apparatus according to the present disclosure;

FIG. 9 describes a configuration in which metal is disposed in close proximity to the antenna element in a conventional example of the antenna apparatus according to the present disclosure;

FIG. 10 is a graph showing VSWR characteristics of a configuration in which metal is disposed in close proximity to the antenna element in a conventional example of the antenna apparatus according to the present disclosure;

FIG. 11 describes a configuration when the coaxial cable is bent midway (cable variation configuration) and a configuration when it is straight (default configuration) according to an embodiment of the antenna apparatus of the present disclosure;

FIG. 12 is a graph showing VSWR characteristics of a configuration when the coaxial cable is bent midway (cable variation configuration) and a configuration when it is straight (default configuration) according to an embodiment of the antenna apparatus of the present disclosure;

FIG. 13 describes a configuration in which the main antenna element is bent through 90° coaxial cable according to an embodiment of the antenna apparatus of the present disclosure;

FIG. 14 is a graph showing VSWR characteristics of a configuration in which the main antenna element is bent through 90° coaxial cable according to an embodiment of the antenna apparatus of the present disclosure;

FIG. 15 describes a configuration in which metal is disposed in close proximity to the impedance adjustment element according to an embodiment of the antenna apparatus of the present disclosure;

FIG. 16 is a graph showing VSWR characteristics of a configuration in which metal is disposed in close proximity to the impedance adjustment element according to an embodiment of the antenna apparatus of the present disclosure;

FIG. 17 is a plan view of an antenna apparatus according to a second embodiment of the antenna apparatus, and a method of manufacture therefor, of the present disclosure;

FIG. 18 is a simplified plan view describing the dimensions and the like of the antenna apparatus according to the second embodiment;

FIG. 19 is a fragmentary view in the direction of the arrow A-A in FIG. 17;

FIG. 20 is a plan view of the main components of an antenna apparatus according to a third embodiment of the antenna apparatus, and a method of manufacture therefor, and a fragmentary view in the direction of the arrow B-B of the present disclosure;

FIG. 21 is a longitudinal sectional view of the main components of an antenna apparatus according to a fourth embodiment of the antenna apparatus, and a method of manufacture therefor, and a fragmentary view in the direction of the arrow C-C of the present disclosure;

FIG. 22 is a plan view of an antenna apparatus according to a fifth embodiment of the antenna apparatus, and a method of manufacture therefor, of the present disclosure;

FIG. 23 is a graph showing VSWR characteristics according to an embodiment of an antenna apparatus and a method of manufacture therefor of the present disclosure;

FIG. 24 is a graph showing the radiation pattern according to an embodiment of an antenna apparatus and a method of manufacture therefor of the present disclosure; and

FIG. 25 describes another constriction method on a base end aperture of a tube of an antenna apparatus and a method of manufacture therefor according to the present disclosure.

### DETAILED DESCRIPTION

The present disclosure is proposed in light of the above problems, and has the object of providing an antenna apparatus that eliminates unstable components resulting from the antenna element connection, and furthermore which suppresses adverse effects on performance due to the peripheral environment and the coaxial cable, and that maintains stable performance in a variety of installation positions.

The present disclosure adopts the following configuration to solve the above problems. More specifically, the antenna apparatus according to the present disclosure is characterized by including a coaxial cable body configured by covering the peripheral portion of a core forming the power feed line with a first coating dielectric unit, a ground line and a second coating dielectric unit in that order, a main antenna element in which the core either singly or in combination with the first coating dielectric unit projects and extends from the distal end of the coaxial cable body, and an impedance adjustment element in which the ground line projects singly from the distal end of the coaxial cable body, and the impedance adjustment element maintains an orientation extending in a direction that differs from the extension direction of the main antenna element and is fixed to the distal end of the coaxial cable body.

Since this antenna apparatus includes a main antenna element in which the core projects and extends from the distal end of the coaxial cable body, and an impedance adjustment element in which the ground line projects singly from the distal end of the coaxial cable body, and the impedance adjustment element maintains an orientation extending in a direction that differs from the extension direction of the main antenna element and is fixed to the distal end of the coaxial cable body, the core forms an antenna element without further modification, and the ground line functions as an impedance adjustment element that adjusts the capacity coupling or the reflection produced between the coaxial cable body and the antenna in response to the direction of extension of the ground line. Consequently the apparatus enables suppression of an effect of the coaxial cable body and the peripheral environment.

Furthermore since the core extends as a main antenna element without further modification, in contrast to the conventional technique, there is no connecting portion with a separately prepared antenna element, and no increase in unstable components resulting from that connecting portion and therefore no adverse effect on performance. Furthermore since the impedance adjustment element is fixed to the distal end of the coaxial cable body in a state that maintains a predetermined direction of extension, deterioration in performance can be suppressed even in the event that there is a change in the base end of the coaxial cable body. Furthermore in contrast to the conventional technique, a separate antenna element member can be omitted and the trouble of extracting the core which is the power feed line from the coaxial cable and connecting with the separate antenna element is eliminated, thereby enabling low-cost production and excellent productivity.

In addition, the core is covered by the first covering dielectric unit due to projecting the core of the coaxial cable body together with the first coating dielectric unit to form the main antenna element. Consequently the need for provision of a separate dielectric portion is eliminated, and the length of the main antenna element can be reduced according to the permittivity of the first covering dielectric unit.

Furthermore the antenna apparatus according to the present disclosure is characterized by setting the direction of extension of the impedance adjustment element to an angle within 90° of the direction of extension of the distal end of the coaxial cable body. More specifically, since the impedance adjustment element in this antenna apparatus extends at an angle that is within 90° of the distal end of the coaxial cable, an effect is obtained which suppresses the capacity coupling between the impedance adjustment element and the coaxial cable body.

The impedance adjustment element of the antenna apparatus according to the present disclosure is characterized in being folded from the distal end of the coaxial cable body and extends along the coaxial cable body. In other words, the impedance adjustment element of the antenna apparatus is configured overall substantially in the shape of a underlined numeral 7 since it is folded at the distal end of the coaxial cable body and extends along the coaxial cable body. Consequently the line capacity with the coaxial cable body can be adjusted in response to the distance between the portion of the impedance adjustment element disposed along the coaxial cable body and the coaxial cable body, and compact mounting is enabled in a confined space such as in an automobile.

Furthermore the antenna apparatus according to the present disclosure is characterized by interposing a spacer between the impedance adjustment element and the coaxial cable body. In other words, this antenna apparatus enables maintenance of a fixed interval between the impedance adjustment element and the coaxial cable body by providing a spacer between the impedance adjustment element and the coaxial cable body. Consequently even when the line capacity increases, downsizing is enabled by changing the permittivity of the spacer.

The antenna apparatus according to the present disclosure is characterized by covering the main antenna element, the impedance adjustment element and the distal end of the coaxial cable body with a tube. More specifically, since the antenna apparatus uses a tube to cover and integrate the main antenna element, the impedance adjustment element and the distal end of the coaxial cable body, the element body is fixed and protected by the tube, stability is improved, and mounting in a vehicle or the like is facilitated by further enabling downsizing.

The antenna apparatus according to the present disclosure is characterized by including a coaxial cable body configured by covering the peripheral portion of a core forming the power feed line with a first coating dielectric unit, a ground line and a second coating dielectric unit in that order, a main antenna element in which the core either singly or in combination with the first coating dielectric unit projects and extends from the distal end of the coaxial cable body, an impedance adjustment element in which the ground line or a connection lead line connected to the ground line is folded from the distal tip of the coaxial cable body, and the impedance adjustment element maintains an orientation extending from the distal tip of the coaxial cable body along the coaxial cable body, and is fixed to the distal end of the coaxial cable body, and a tube covering the main antenna element, the impedance adjustment element, and the distal end of the coaxial cable body, and that at least constricts the base end aperture.

The antenna apparatus includes a main antenna element in which the core projects and extends from the distal end of the coaxial cable body, and an impedance adjustment element in which the ground line or a connection lead line connected to the ground line is folded from the distal tip of the coaxial cable body, and the impedance adjustment element maintains an orientation extending from the distal tip of the coaxial cable body along the coaxial cable body, and is fixed to the distal end of the coaxial cable body, the core is configured as an antenna element without further modification, and the ground line or the connection lead line is configured as an impedance adjustment element that adjusts the capacity coupling or the reflection produced between the coaxial cable body and the antenna in response to the direction of extension of the ground line or the connection lead line to thereby suppress an effect of the coaxial cable body or an effect of the peripheral environment.

Furthermore since the tube covers the main antenna element, the impedance adjustment element and the distal end of the coaxial cable body and constricts at least the base end aperture, stability is improved by specifying the direction of extension, and by protecting and supporting the entire element with the tube that constricts the base end aperture and prevents detachment.

The tube in the antenna apparatus according to the present disclosure is characterized in being a thermal-shrinkage tube, and the base end aperture is constricted by thermal shrinkage. More specifically, since the tube in the antenna apparatus is a thermal-shrinkage tube and the base end aperture is constricted by thermal shrinkage, the base end aperture can be simply constricted by application of heat.

The distal end aperture of the tube of the antenna apparatus according to the present disclosure is characterized by being closed. More specifically, since the distal end aperture of the tube of the antenna apparatus is closed, deviation of the tube and projection of the main antenna element from the distal end aperture can be prevented. For example, closure can be performed by closing the distal end aperture of the tube with an adhesive or sealing with a sealant.

The antenna apparatus according to the present disclosure is characterized by forming an intermediate constricted portion that is an intermediate portion of the tube and has a restricted diameter at a position forward of the distal end of the coaxial cable body and the impedance adjustment element. More specifically, since the antenna apparatus includes an intermediate constricted portion that is an intermediate portion of the tube and has a restricted diameter at a position forward of the distal end of the coaxial cable body and the impedance adjustment element, displacement of the impedance adjustment element and the coaxial cable body is restricted about the distal ends thereof by the intermediate constricted portion and the base end aperture that have a restricted diameter, and therefore detachment and deviation can be prevented.

The antenna apparatus according to the present disclosure is characterized by including at least one or a plurality of element fixing members that is provided in the tube, and that fixes at least one of the distal end and the intermediate portion of the main antenna element to an inner face of the tube. More specifically, since the antenna apparatus includes at least one or a plurality of element fixing members that is provided in the tube, and that fixes at least one of the distal end and the intermediate portion of the main antenna element to an inner face of the tube, the production of abnormal noises resulting from vibration of the main antenna element causing contact with the inner surface of the tube can be prevented.

The tube of the antenna apparatus according to the present disclosure is characterized by being formed from a transparent or semi-transparent material. More specifically, since the tube of the antenna apparatus is formed from a transparent or semi-transparent material, visual inspection of the interior is enabled and the orientation of each element can be checked.

The tube of the antenna apparatus according to the present disclosure is characterized by being formed from a fire-resistant material. More specifically, since the tube of the antenna apparatus may be formed from a fire-resistant material, in embodiments the fire-resistant material does not contain a halogen element (for example, a material in which a fire-resistant material not containing a halogen element such as magnesium hydroxide or aluminum hydroxide, or the like is combined with a fire-resistant agent), and thereby has a material configuration adapted to the environment upon disposal.

The tube of the antenna apparatus according to the present disclosure is characterized by having a flattened sectional shape. More specifically, since the tube of the antenna apparatus has a flattened sectional shape, mounting in a confined position such as an automobile pillar is facilitated, and even in the event that the mounting position is curved, disposition adapted to the mounting position is enabled.

The antenna apparatus according to the present disclosure is characterized by connecting a high-frequency connector to the base end of the coaxial cable body. More specifically, since the antenna apparatus connects a high-frequency connector to the base end of the coaxial cable body, connection to a high-frequency circuit is facilitated.

A method of manufacturing an antenna apparatus according to the present disclosure includes a step of preparing an antenna apparatus main body including a coaxial cable body configured by covering the peripheral portion of a core forming the power feed line with a first coating dielectric unit, a ground line and a second coating dielectric unit in that order, a main antenna element in which the core either singly or in combination with the first coating dielectric unit projects and extends from the distal end of the coaxial cable body, and an impedance adjustment element in which the ground line or a connection lead line connected to the ground line is folded from the distal tip of the coaxial cable body, the impedance adjustment element maintaining an orientation extending from the distal tip of the coaxial cable body along the coaxial cable body and fixed to the distal end of the coaxial cable body, a step of covering the main antenna element, the impedance adjustment element and the distal end of the coaxial cable body with a heat-shrinkage tube, and a step of heating to thereby shrink and contract the base end aperture of the heat-shrinkage tube.

More specifically, since the method of manufacturing an antenna apparatus includes the step of covering the main antenna element, the impedance adjustment element and the distal end of the coaxial cable body with a heat-shrinkage tube, and the step of heating to thereby shrink and contract the base end aperture of the heat-shrinkage tube, prevention of detachment is enabled by merely heating the heat-shrinkage tube, and preparation of an antenna apparatus is facilitated in which the overall elements are protected and supported by the heat-shrinkage tube. The step of covering with the heat-shrinkage tube and the step of heat-shrinking and constricting can be performed in either order. However in light of the effect of heating on the overall antenna apparatus main body, in embodiments the step of heat-shrinking and constricting may be performed first, and then covering with the heat-shrinkage tube.

More specifically, since the antenna apparatus according to the present disclosure includes a main antenna element in which the core either singly or in combination with the first coating dielectric unit projects and extends from the distal end of the coaxial cable body, and an impedance adjustment element in which the ground line is separated from the core and projects singly from the distal end of the coaxial cable body, and the impedance adjustment element maintains an orientation extending in a direction that differs from the extension direction of the main antenna element and is fixed to the distal end of the coaxial cable body, cost-effective manufacture is enabled in addition reducing the number of unstable components resulting from conventional connections and the like. Furthermore adverse effects on performance can be reduced in relation to the coaxial cable body and the peripheral environment.

Since the antenna apparatus and the method of manufacturing the same according to the present disclosure includes a main antenna element in which the core projects and extends from the distal end of the coaxial cable body, and an impedance adjustment element in which the ground line or a connection lead line connected to the ground line is folded from the distal tip of the coaxial cable body, the impedance adjustment element maintaining an orientation extending from the distal tip of the coaxial cable body along the coaxial cable body and fixed to the distal end of the coaxial cable body, cost-effective manufacture is enabled in addition reducing the number of unstable components resulting from conventional connections and the like. Furthermore adverse effects on performance can be reduced in relation to the coaxial cable body and the peripheral environment.

Furthermore since the main antenna element, the impedance adjustment element and the distal end of the coaxial cable body are covered, and a tube is provided in which at least the base end aperture is constricted, the overall elements can be protected and supported by the tube that is prevented from detaching by constricting the base end aperture to thereby improve stability.

Therefore the antenna apparatus according to the present disclosure finds suitable application to a wireless communication system that is mounted in an automobile or the like, and enables stable installation while inhibiting environmental effects and enables superior performance when mounted in an automobile or the like.

The embodiments of the antenna apparatus according to the present disclosure will be described below making reference to the figures. In the various figures used in the following description the scale has been suitably varied to a size that enables or facilitates recognition of respective members.

The first embodiment will be described making reference to FIG. 1 to FIG. 3.

An antenna apparatus 1 according to the present embodiment is used in a vehicle-mounted wireless communication technique such as a remote engine starter, a keyless operation system, a keyless entry system, or the like. As shown in FIG. 1 to FIG. 3, the antenna apparatus 1 includes a coaxial cable body 6 configured by covering the peripheral portion of a core 2 forming the power feed line connected to the antenna power feed portion (not shown) of the wireless circuit with a first coating dielectric unit 3, a ground line 4 and a second coating dielectric unit 5 in that order, a main antenna element 7 in which the core 2 in combination with the first coating dielectric unit 3 projects and extends from the distal end of the coaxial cable body 6, and an impedance adjustment element 8 in which the ground line 4 projects singly from the distal end of the coaxial cable body 6, and the impedance adjustment element maintains an orientation extending in a direction that differs from the extension direction of the main antenna element 7 and is fixed to the distal end of the coaxial cable body 6.

A remote engine starter is an apparatus that starts and stops the engine of an automobile with a remote operation by a remote controller.

A keyless operation system or a keyless entry system are systems in which a portable key having a wireless communication function termed a keyless operation key or a keyless entry key is retained by a driver. When approaching an automobile within a wireless operation range, an ID code is verified by wireless communication between the key and a reception antenna apparatus installed on the automobile body to thereby enable locking and unlocking of the automobile doors and tailgate (a so-called keyless entry system), and starting operations for the engine.

The core 2 is formed by a stranded copper line, and the ground line 4 for example is formed by a fine braided copper line. Furthermore the first covering dielectric unit 3 and the second covering dielectric unit 5 are formed from an insulating material, such as foam polyethylene, tetrafluoroethylene resin, or the like.

The main antenna element 7 is set to a standard in which the length from the distal end of the coaxial cable body 6 has a value corresponding to ¼ of the wavelength of a desired frequency.

The direction of extension of the impedance adjustment element 8 is to an angle within 90° of the direction of extension of the distal end of the coaxial cable body 6. In particular, in the present embodiment, the impedance adjustment element 8 is folded from the distal end of the coaxial cable body 6 and extends along the coaxial cable body 6.

More specifically, an overall configuration substantially in the shape of a underlined numeral 7 results from the folded impedance adjustment element 8. The impedance adjustment element 8 is configured by a vertical portion 8a extending by only a length a in a direction diverging from the distal end of the coaxial cable body 6 (a vertical direction relative to the distal tip of the coaxial cable body 6) and an extension portion 8b extending parallel by only a length b along the coaxial cable body 6.

The length a of the vertical portion 8a is acquired from the line capacity produced with the coaxial cable body 6, and takes different values depending on the length and thickness of the coaxial cable body 6. The present embodiment obtains the effect that control of the line capacity suppresses adverse effects on performance due to changes in the coaxial cable body 6 or adverse effects on performance when in near with metal.

The length b of the vertical portion 8b is determined from the relationship with the wavelength relative to a desired frequency. In the present embodiment, although the impedance adjustment element 8 includes an extension portion 8b that is parallel to the coaxial cable body 6, there is not always a requirement for the portion to be parallel, and as shown above, the extension may be in a direction that differs from the extension direction of the main antenna element 7.

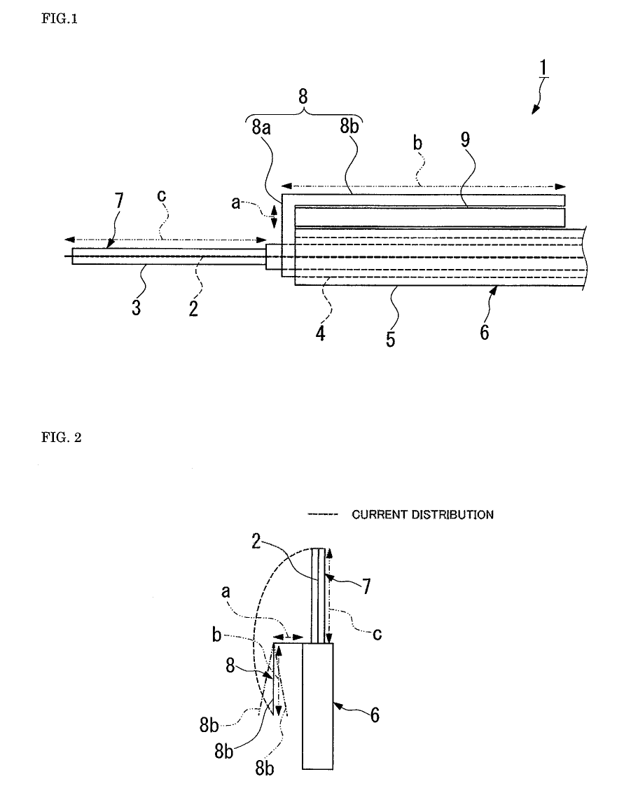

For example, as shown in FIG. 2, since the distal end of the extension portion 8b has a relatively high impedance, the distal tip of the extension portion 8b may separate from or approach the coaxial cable body 6 by more than the length a as a result of the relationship of the length a of the vertical portion 8a and the structure of the coaxial cable body 6. Consequently the impedance between the coaxial cable body 6 and the antenna is adjusted by the impedance adjustment element 8.

The length c of the main antenna element 7 which forms the power feed line is set to a standard of a length that is ¼ of a desired frequency as described above. However it may vary due to the structure of the coaxial cable body 6 or the length of the impedance adjustment element 8. Normally, the length c of the main antenna element 7 is often shorter than a length that is ¼ of the frequency. This is in order to produce a shortening effect by the thickness and material of the first coating dielectric unit 3 of the main antenna element 7. The relationship between the length a of the vertical portion 8a, the length b of the extension portion 8b and the length c of the main antenna element 7 is given below:

a+b=c or a+b≈c or a+b≦c or a+b≧c

(Wherein: a≠0)

A spacer 9 is interposed between the impedance adjustment element 8 and the coaxial cable body 6. The spacer 9 is a molded product formed from an insulating resin material or rubber material, and for example, is formed as a dielectric having a fixed permittivity such as a resin including a foam styrene, or a ceramic or the like. The spacer 9 has the role of maintaining a stable distance between the extension portion 8b of the impedance adjustment element 8 and the coaxial cable body 6, in other words, the distance a of the vertical portion 8a.

The spacer 9 may have a minute length due to the thickness for example of the coaxial cable body 6, and if within a permitted range, it may be omitted. Conversely, when the line capacity increases as a result of the structure of the coaxial cable body 6, downsizing is enabled by varying the permittivity of the material used in the spacer 9.

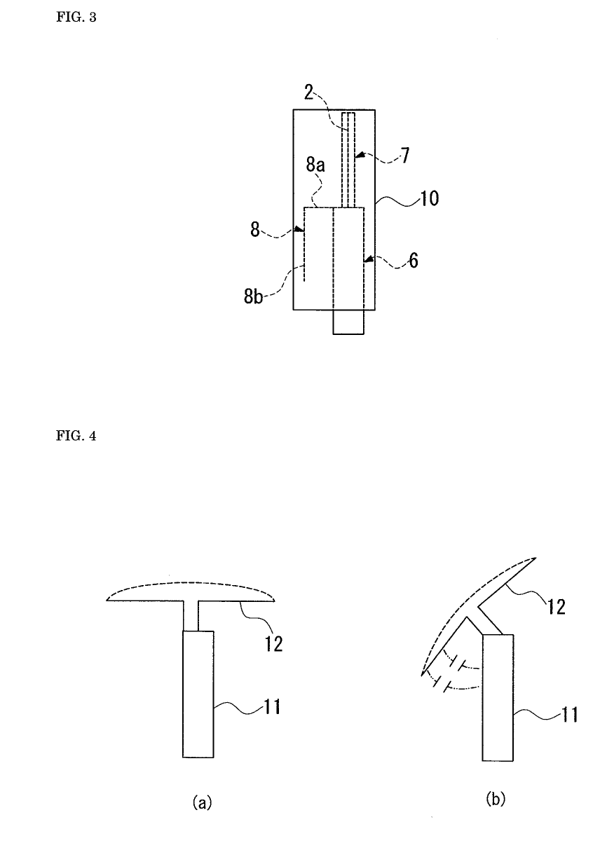

As shown in FIG. 3, the main antenna element 7, the impedance adjustment element 8 and the distal end of the coaxial cable body 6 are covered with a tube 10 formed from insulating material.

The tube 10 has a tubular shape and is formed from an insulating resin material or rubber material, and for example, a corrugated tube, a heat-shrinkage tube, or a tube formed from a sheet or a band of a resin material or rubber material wrapped and fixed about the outer periphery of the antenna may be used.

Next, a method of manufacturing the antenna apparatus 1 according to the present embodiment will be described.

For example, there is a method in which the second covering dielectric unit 5 is peeled and the braided wire forming the ground wire 4 is disentangled and bundled to form a single bundled line, and fixed to extend in a direction that is different to the extension direction of the main antenna element 7.

In embodiments, the impedance adjustment element 8 is set to an angle within 90° with respect to the direction of extension of the distal end of the coaxial cable body 6, and still is folded from the distal end of the coaxial cable body 6 and extended and fixed along the coaxial cable body 6. The spacer 9 is interposed between the impedance adjustment element 8 and the coaxial cable body 6 at this time to thereby enable stable maintenance of the dimensions of the vertical unit 8a shown in FIG. 1. The overall antenna apparatus 1 is covered and protected by the tube 10 to thereby obtain more stable antenna performance.

Another method of production is a method in which a lead line is joined to the main antenna element 7, the lead line is joined to the braided line, and that lead line is fixed as the impedance regulation element 8 and extends in a direction that is different to the direction of extension of the main antenna element 7. In the same manner as the method of preparation above, the impedance adjustment element 8 is formed from the lead line is set to an angle within 90° with respect to the direction of extension of the distal end of the coaxial cable body 6, and is folded from the distal end of the coaxial cable body 6 and extended and fixed along the coaxial cable body 6. This method of preparation is advantageous over the method of preparation above due to enabling preparation and use without modification of the braided line that is the component configuring the coaxial cable body 6.

In the antenna apparatus 1 according to the present embodiment, since the main antenna element 7 includes the core 2 that protrudes and extends from the distal end of the coaxial cable body 6, and the impedance adjustment element 8 in which the ground line 4 projects from the distal end of the coaxial cable body 6, and the impedance adjustment element maintains an orientation extending in a direction that differs from the extension direction of the main antenna element 7 and is fixed to the distal end of the coaxial cable body 6, the core 2 forms the main antenna element 7 without further modification, and the ground line 4 forms the impedance adjustment element 8 that adjusts the reflection or the quantity coupling produced between the coaxial cable body 6 and the antenna in response to the direction of extension of the ground line 4. Therefore the effect of the coaxial cable body 6 and the peripheral environment can be suppressed.

Furthermore since the core 2 extends as the main antenna element 7 without further modification, in contrast to the conventional technique, there is no connecting portion with a separately prepared antenna element member, no increase in unstable components caused by such a connecting portion, and therefore no adverse effect on performance. Furthermore since the impedance adjustment element 8 is fixed and maintained in a predetermined direction on the distal end of the coaxial cable body, even in the event that there is a change in the base end of the coaxial cable body 6, deterioration in performance can be suppressed. Furthermore in contrast to the conventional technique, a separate antenna element member can be omitted, and the trouble of extracting the core which is the power feed line from the coaxial cable and connecting with the separate antenna element is eliminated, thereby enabling low-cost production and excellent productivity.

In addition, since the core 2 of the coaxial cable body 6 projects together with the first coating dielectric unit 3 to form the main antenna element 7, the core 2 is covered by the first coating dielectric unit 3. Consequently a need for provision of a separate dielectric portion is eliminated, and the length of the main antenna element 7 can be reduced according to the permittivity of the first covering dielectric unit 3.

Furthermore since the impedance adjustment element 8 extends at an angle within 90° with respect to the distal end of the coaxial cable body 6, an effect of suppressing the capacity coupling between the impedance adjustment element 8 and the coaxial cable body 6 is enabled. In particular, the impedance adjustment element 8 is folded at the distal end of the coaxial cable body 6 and extends along the coaxial cable body 6, and is therefore configured overall substantially in the shape of a underlined numeral 7. Consequently the line capacity with the coaxial cable body 6 can be adjusted in response to the distance between the coaxial cable body 6 and the portion of the impedance adjustment element 8 disposed along the coaxial cable body 6, and mounting is enabled in a confined space such as in a vehicle.

In other words, it is of course possible to install in the vehicle cabin of a vehicle, and in particular, since installation is possible in an extremely confined space such as a pillar or the like, the effect is obtained that the antenna apparatus 1 can be installed without adverse effect on the external appearance (design) of the vehicle interior.

Furthermore since a spacer 9 is installed between the impedance adjustment element 8 and the coaxial cable body 6, a fixed interval is maintained between the impedance adjustment element 8 and the coaxial cable body 6. Consequently even when the line capacity increases, downsizing is enabled by changing the permittivity of the spacer 9.

Since the main antenna element 7, the impedance adjustment element 8 and the distal end of the coaxial cable body 6 are covered and integrated by the tube 10, the overall elements are protected by the tube 10, thus enabling an improvement in fixation and stability properties, and facilitates mounting in a vehicle or the like by further enabling downsizing.

Next the evaluation results of an actually prepared example in an antenna apparatus according to the present disclosure will be described in detail by comparison with a conventional example.

Firstly as shown in FIG. 4(a), the antenna element 12 of an ideal dipole antenna is disposed with bilateral symmetry with respect to a coaxial cable 11. However realization of this configuration is difficult due to restrictions such as installation conditions and the like. In an antenna apparatus using a conventional technique which is accordingly formed substantially in the shape of an inverted chevron, as shown in FIG. 4(b), the shape substantially in shape of an inverted chevron causes an adverse effect on the performance due to quantity coupling with the coaxial cable.

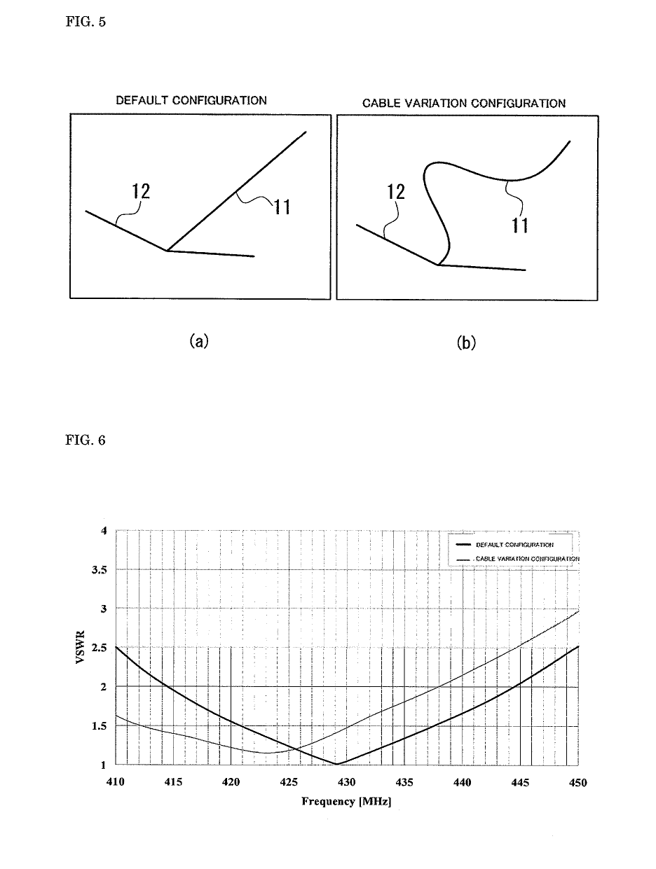

For example, an actual example of a conventional antenna apparatus may have a configuration in which the antenna element 12 is fixed and the coaxial cable 11 extends straight (default configuration) as shown in FIG. 5(a), or in which the coaxial cable 11 is varied into a curved shape (cable variation configuration) as shown in FIG. 5(b). The results of measuring the VSWR (voltage standing wave ratio) performance of the respective configurations are shown in FIG. 6. As shown by the results, in contrast to a default configuration, the cable variation configuration shifts the resonance frequency to a low 7 MHz range.

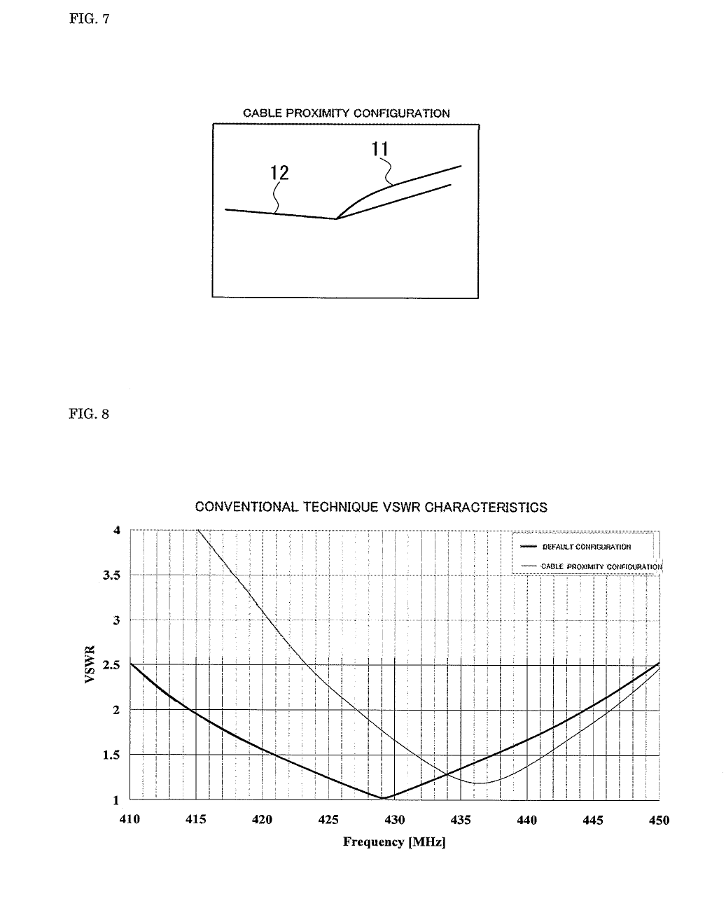

The whole antenna element 12 may be inclined and placed in proximity to the coaxial cable 11 with the coaxial cable 11 fixed as shown in FIG. 7. The results of measuring the VSWR performance for this configuration in the same manner are shown in FIG. 8. In this case, the resonance frequency is shifted towards a higher 7 MHz range in contrast to the default configuration.

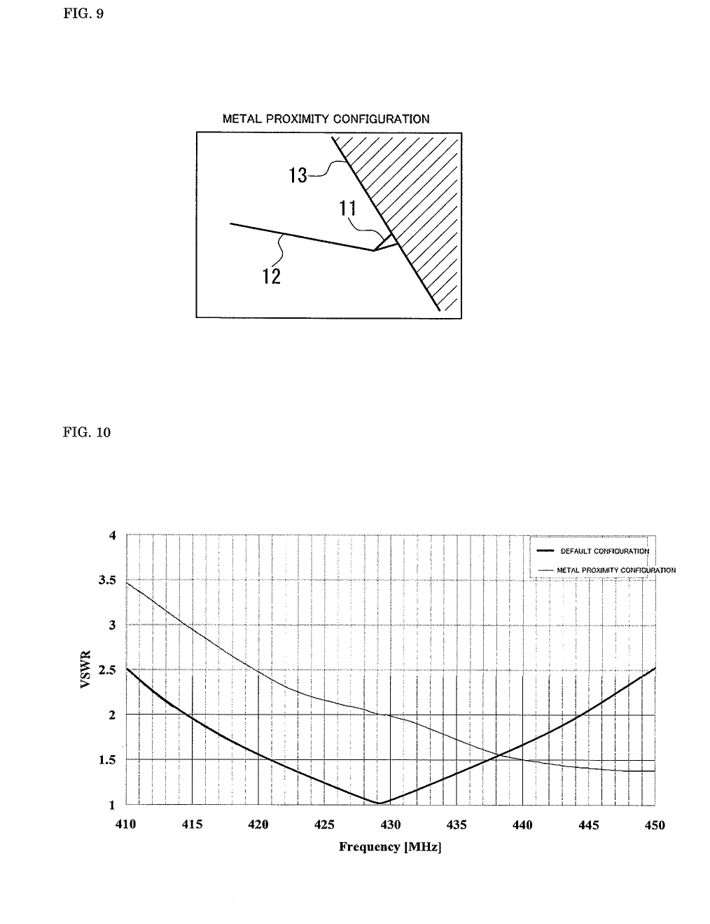

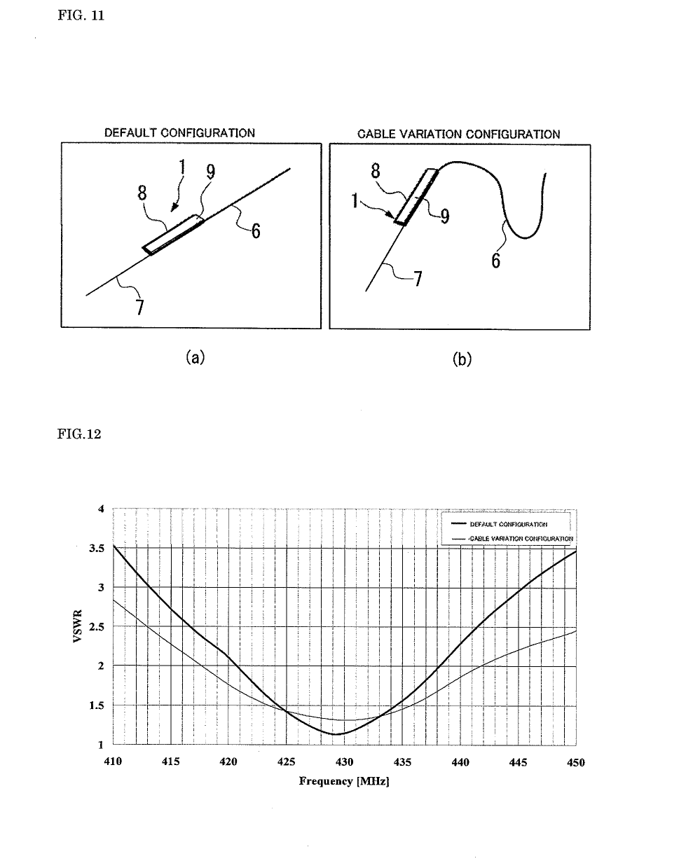

A metal 13 may be placed in proximity to the ground-side elements of the antenna element 12 as shown in FIG. 9. The results of measuring the VSWR performance for this configuration in the same manner are shown in FIG. 10. In this case, the resonance frequency is shifted towards a higher 20 MHz range in contrast to the default configuration.

Therefore it can be understood that the conventional technique shifts the resonance frequency due to variation of the coaxial cable, installation of an antenna element, or proximity to a metal. In other words, when actually mounted in a real vehicle such as an automobile, there is a risk of further adverse effects on performance due to those reasons in addition to an increase in unstable components caused by connections.

In contrast, FIG. 12 shows the results of measuring the VSWR performance of the antenna apparatus 1 according to the present embodiment for example, when the antenna apparatus 1 is fixed and the coaxial cable body 6 extends substantially straight (default configuration) as shown in FIG. 11(a), or when the coaxial cable body 6 is varied into a curved shape (cable variation configuration) as shown in FIG. 11(b).

As shown by the results, in the present embodiment in contrast to a default configuration, the cable variation configuration also displays almost no change in the resonance frequency. This is due to the fact that the impedance adjustment element 8 acts to cancel impedance or phase shift resulting from reflected waves produced by variation to the coaxial cable body 6.

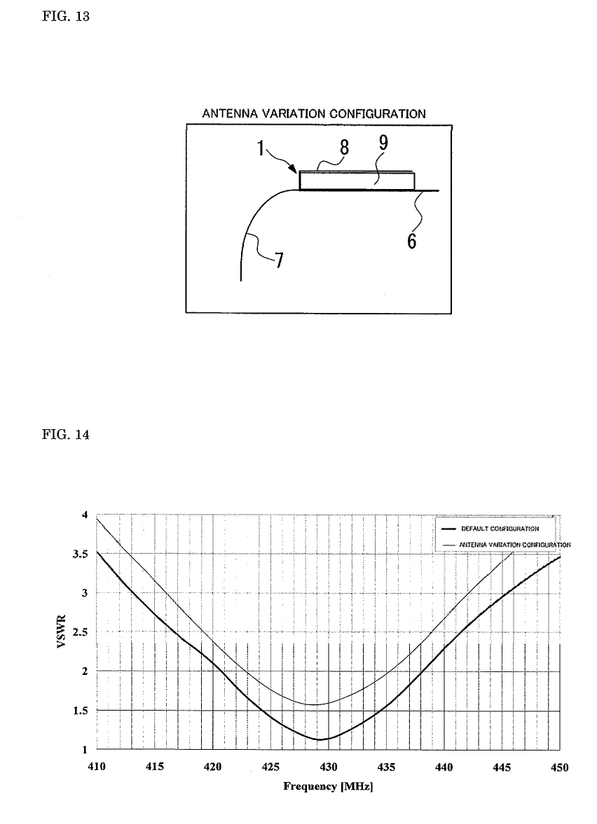

The main antenna element 7 may be bent through 90° with respect to the coaxial cable body 6 with the coaxial cable body 6 fixed as shown in FIG. 13. The results of measuring the VSWR performance for this configuration are shown in FIG. 14. As shown by the results, even when the main antenna element 7 is varied, there is almost no change in the resonance frequency. Although a frequency deviation is produced with respect to a change in the original main antenna element 7, it is considered that such a deviation is cancelled out by the elements on the other side, in other words, the impedance adjustment element 8, and therefore a change in the resonance frequency is suppressed. This is due to the fact that the present embodiment has a structure which adjusts the current distribution flowing through the main antenna element 7 and the coaxial cable body 6 to thereby maximize radiation efficiency.

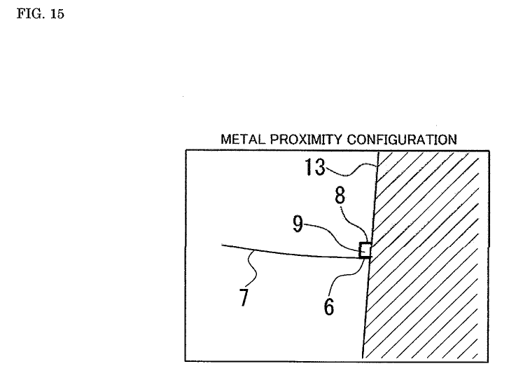

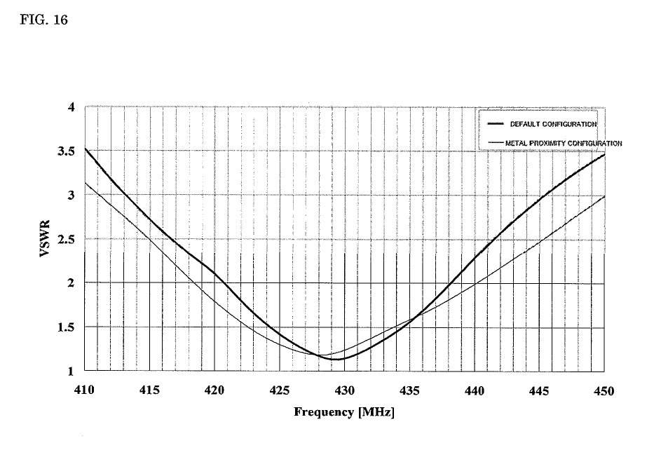

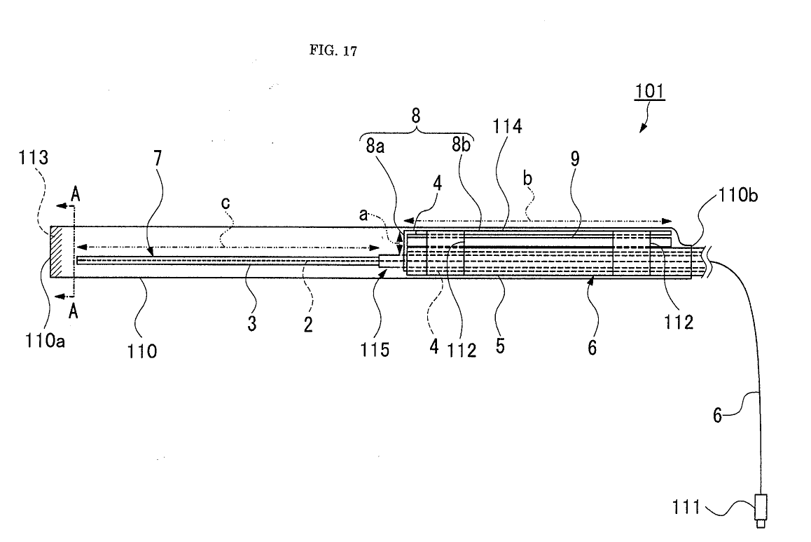

FIG. 16 shows the results of measuring VSWR performance when the metal 13 is in proximity to the impedance adjustment element 8 as shown in FIG. 15. As shown by the results, even when the metal 13 is placed in proximity, there is almost no change in the resonance frequency. Since the impedance adjustment element 8 adjusts impedance by cancelling the capacity coupling with the coaxial cable body 6, it is thought that the capacity coupling which is produced in the same manner is cancelled even when the metal 13 approaches.

In this manner, the antenna apparatus 1 according to the present embodiment does not cause any deterioration in performance that is observed in the conventional techniques in relation to the above three types of environmental change.

Next a second embodiment of the antenna apparatus according to the present disclosure will be described with reference to FIG. 17 to FIG. 19.

The antenna apparatus 101 according to the present embodiment in the same manner as the first embodiment is used in a remote engine starter or a keyless entry system mounted in an automobile or the like. As shown in FIG. 17, the antenna apparatus 101 includes a coaxial cable body 6 configured by covering the peripheral portion of the core 2 forming the power feed line that is connected with an antenna power feed portion (not shown) for the wireless circuit with the first coating dielectric unit 3, the ground line 4 and the second coating dielectric unit 5 in that order, the main antenna element 7 in which the core 2 extends and projects with the first coating dielectric unit 3 from the distal end of the coaxial cable body 6, and an impedance adjustment element 8 maintaining an orientation in which a connection lead line 114 connected to the ground line 4 is bent from the distal end of the coaxial cable body 6, and the impedance adjustment element 8 extends from the distal end of the coaxial cable body 6 along the coaxial cable body 6, and is fixed to the distal end of the coaxial cable body 6, and a thermal-shrinkage tube (tube) 110 that covers the main antenna element 7, the impedance adjustment element 8 and the distal end of the coaxial cable body 6.

The core 2 is formed by a copper stranded line, and the ground line 4 for example is formed by a fine braided copper line. Furthermore the first covering dielectric unit 3 and the second covering dielectric unit 5 are formed from an insulating material, such as foam polyethylene or tetrafluoroethylene resin.

The distal end of the ground line 4 is formed by disentangling the braiding of the braided line and bundling each line forming the braided line into a single line, and then connecting by soldering with the base end of the connection lead line 114 that is formed by vinyl wire.

A small high-frequency connector 111 such as an MMCX type is connected to the base end of the coaxial cable body 6.

The main antenna element 7 is set to a standard in which the length from the distal end of the coaxial cable body 6 has a value corresponding to ¼ of the wavelength of a desired frequency.

In this embodiment, the impedance adjustment element 8 is folded from the distal end of the coaxial cable body 6 and extends along the coaxial cable body 6 as described above.

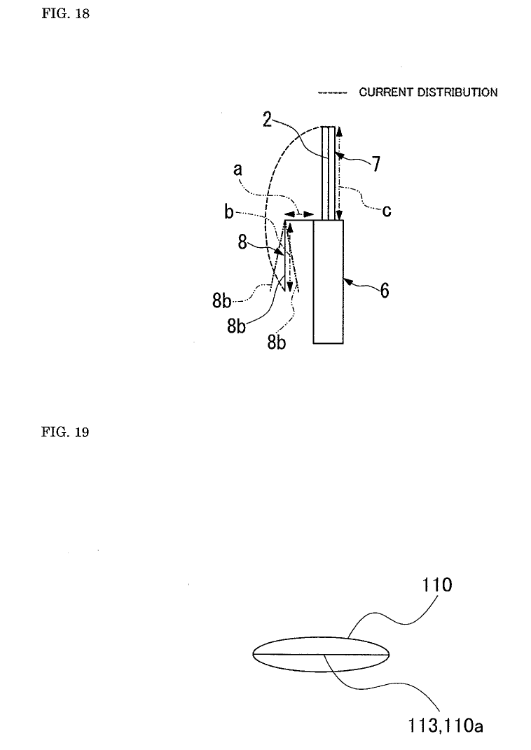

In other words, as shown in FIG. 18, an overall configuration substantially in the shape of a underlined numeral 7 results from the folded impedance adjustment element 8. The impedance adjustment element 8 is configured by the vertical portion 8a extending by only a length a in a direction diverging from the distal end of the coaxial cable body 6 (a vertical direction relative to the distal tip of the coaxial cable body 6) and an extension portion 8b extending parallel by only a length b along the coaxial cable body 6.

The length a of the vertical portion 8a is acquired from the line capacity produced with the coaxial cable body 6, and takes different values depending on the length and thickness of the coaxial cable body 6. The present embodiment obtains the effect that control of the line capacity enables suppression of adverse effects on performance due to changes in the coaxial cable body 6 or adverse effects on performance when near a metal.

The length b of the vertical portion 8b is determined from the relationship with the wavelength relative to a desired frequency. In the present embodiment, although the impedance adjustment element 8 includes an extension portion 8b that is parallel to the coaxial cable body 6, there is not always a requirement for the portion to be parallel, and as shown above, extension may be in a direction that differs from the extension direction of the main antenna element 7.

For example, as shown in FIG. 18, since the distal end of the extension portion 8b has a relatively high impedance, the distal tip of the extension portion 8b may separate from or approach the coaxial cable body 6 by more than the length a as a result of the relationship of the length a of the vertical portion 8a and the structure of the coaxial cable body 6. Consequently the impedance between the coaxial cable body 6 and the antenna is adjusted by the impedance adjustment element 8.

The length c of the main antenna element 7 which forms the power feed line is set to a standard of a length that is ¼ of a desired frequency as described above. However it may vary due to the structure of the coaxial cable body 6 or the length of the impedance adjustment element 8. Normally, the length c of the main antenna element 7 is often shorter than a length that is ¼ of the frequency. This is in order to produce a shortening effect by the thickness and material of the first coating dielectric unit 3 of the main antenna element 7. The relationship between the length a of the vertical portion 8a, the length b of the extension portion 8b and the length c of the main antenna element 7 is given below:

a+b=c or a+b≈c or a+b≦c or a+b≧c

(Wherein: α≠0)

The spacer 9 is interposed between the impedance adjustment element 8 and the coaxial cable body 6. The spacer 9 is a molded product formed from an insulating resin material or rubber material, and for example, is formed as a dielectric having a fixed permittivity such as a resin including a foam styrene, or a ceramic or the like. The spacer 9 has the role of maintaining a stable distance between the extension portion 8b of the impedance adjustment element 8 and the coaxial cable body 6, in other words, the distance a of the vertical portion 8a.

The spacer 9 may have a minute length due to the thickness for example of the coaxial cable body 6, and if within a permitted range, it may be omitted. Conversely, when the line capacity increases as a result of the structure of the coaxial cable body 6, downsizing is enabled by varying the permittivity of the material used in the spacer 9.

The impedance adjustment element 8, the coaxial cable body 6 and the spacer 9 are fixed by winding an insulating tape 112 to a plurality of positions.

Furthermore the main antenna element 7, the impedance adjustment element 8 and the distal end of the coaxial cable body 6 are covered with a thermal-shrinkage tube 110 formed from insulating material.

As shown in FIG. 19, the tube 110 has a flat sectional shape and is formed from a thermal-shrinkage transparent or semi-transparent resinous material. For example, the material used in the thermal-shrinkage tube 110 includes fluorine contained resin composition, a polyethylene resinous composition or the like.

The base end aperture 110b of the thermal-shrinkage tube 110 is constricted by thermal shrinkage.

Furthermore the distal end aperture 110a, that is the open end of the thermal-shrinkage tube 110, is closed by adhesion using an adhesive agent 113. The adhesive agent 113 for example may be a hot-melt adhesive that is melted by application of heat and then cooled and hardened. In this case, the distal end aperture 110a of the thermal-shrinkage tube 110 can be subjected to thermal shrinkage by heating the adhesive at the same time.

When adhering the distal end aperture 110a of the thermal-shrinkage tube 110, the distal end of the main antenna element 7 may be adhered and fixed together.

Next, a method of manufacturing the antenna apparatus 101 according to the present embodiment will be described.

For example, there is a method in which the second covering dielectric unit 5 is peeled and the braided wire forming the ground wire 4 is disentangled to expose the main antenna element 7 that is formed from the core 2 and the first covering dielectric unit 3. Then a connection lead line 114 is connected by soldering to the portion at which the braided wire forming the ground wire 4 is bundled to form a single bundled line. Then the bundled ground line 4 and the connection lead line 114 are bent from the distal tip of the coaxial cable body 6, extend along the coaxial cable body 6 and fixed with tape 112. The spacer 9 is then interposed between the impedance adjustment element 8 and the coaxial cable body 6 stably maintain the dimension a of the vertical portion 8a shown in FIG. 17. The antenna apparatus main body 115 is prepared in this manner.

Next a thermal-shrinkage tube 110 is prepared, and the base end aperture 110b of the tube 110 is heated to thereby constrict by thermal shrinkage. The level of constriction of the base end aperture 110b enables passage of the coaxial cable body 6 but does not enable passage of the portion of the spacer 9 and the impedance adjustment element 8 of the antenna apparatus 115. In embodiments, constriction may be conducted after inserting a tool having a predetermined diameter in advance into the base end aperture 110b of the thermal-shrinkage tube 110. In this case, the diameter size during shrinkage is stable.

Next in order to obtain more stable antenna performance, the main antenna element 7, the impedance adjustment element 8 and the distal end of the coaxial cable body 6 are covered and protected by the thermal-shrinkage tube 110. The coaxial cable body 6 is inserted from the non-constricted distal end aperture 110a, passes to the constricted base end aperture 110b, and the coaxial cable body 6 is passed in that manner until it engages with the portion of the spacer 9 and the impedance adjustment element 8. Since the base end aperture 110b of the thermal-shrinkage tube 110 is heated and constricted in advance, the reason for passing through the antenna apparatus main body 115 to avoid an effect that may result from heating of an unintended position after passing through the antenna main body 115 and applying heat for thermal shrinkage.

The antenna apparatus 101 is prepared by adhering and closing the distal end aperture 110a of the thermal-shrinkage tube 110 with the adhesive agent 113.

Since the antenna apparatus 101 according to the present embodiment includes the main antenna element 7 in which the core 2 protrudes and extends from the distal end of the coaxial cable body 6, and an impedance adjustment element 8 maintaining an orientation in which a connection lead line 114 connected to the ground line 4 is bent from the distal end of the coaxial cable body 6, and the impedance adjustment element 8 extends from the distal end of the coaxial cable body 6 along the coaxial cable body 6 and is fixed to the distal end of the coaxial cable body 6, the core 2 forms the main antenna element 7 without further modification, and the connection lead line 114 forms the impedance adjustment element 8 that adjusts the reflection or the quantity coupling produced between the coaxial cable body 6 and the antenna in response to the direction of extension of the connection lead line 114. Therefore the effect of the coaxial cable body 6 and the peripheral environment can be suppressed.

Furthermore since the core 2 extends as the main antenna element 7 without further modification, in contrast to the conventional technique, there is no connecting portion with a separately prepared antenna element member, no increase in unstable components caused by such a connecting portion, and therefore no adverse effect on performance. Furthermore since the impedance adjustment element 8 is fixed and maintained in a predetermined direction on the distal end of the coaxial cable body 6, even in the event that there is a change in the base end of the coaxial cable body 6, deterioration in performance can be suppressed. Furthermore in contrast to the conventional technique, a separate antenna element member can be omitted, and the trouble of extracting the core which is the power feed line from the coaxial cable and connecting with the separate antenna element is eliminated, thereby enabling low-cost production and excellent productivity.

In addition, since the core 2 of the coaxial cable body 6 projects together with the first coating dielectric unit 3 to form the main antenna element 7, the core 2 is covered by the first coating dielectric unit 3. Consequently a need for provision of a separate dielectric portion is eliminated, and the length of the main antenna element 7 can be reduced according to the permittivity of the first covering dielectric unit 3.

Furthermore since the impedance adjustment element 8 is bent from the distal end of the coaxial cable body 6 and extends along the coaxial cable body 6, therefore the overall configuration is substantially in the shape of a underlined numeral 7. Consequently the line capacity with the coaxial cable body 6 can be adjusted in response to the distance between the coaxial cable body 6 and the portion of the impedance adjustment element 8 disposed along the coaxial cable body 6, and compact mounting is enabled in a confined space such as in a vehicle.

Since a thermal-shrinkage tube 110 is provided that covers the main antenna element 7, the impedance adjustment element 8 and the distal end of the coaxial cable body 6 and that constricts the base end aperture 110b, stability is improved by the thermal-shrinkage tube 110 that constricts and secures the base end aperture 110b and protects and supports the overall elements to thereby specify a direction of extension.

Since the thermal-shrinkage tube 110 has a flattened sectional shape, it is easily mounted even in confined positions, and even when the mounting position is curved, it can be installed along the mounting position.

In other words, in addition to naturally being adapted for mounting in the vehicle compartment of a vehicle, since installation is also enabled in an extremely confined space such as a pillar or the like, the effect is obtained that the antenna apparatus 1 can be installed without adverse effect on the external appearance (design) of the vehicle interior.

Furthermore since the thermal-shrinkage tube 110 is formed from a transparent or semi-transparent material, visual inspection of the interior is enabled and the orientation of each element can be checked.

Furthermore since the spacer 9 between the impedance adjustment element 8 and the coaxial cable body 6, a fixed interval can be maintained between the impedance adjustment element 8 and the coaxial cable body 6. Consequently even when the line capacity increases, downsizing is enabled by changing the permittivity of the spacer 9.

Since a high-frequency connector 111 is connected to the base end of the coaxial cable body 6, connection to a high-frequency circuit is facilitated.

Furthermore the method of manufacturing the antenna apparatus 101 includes a step of covering the main antenna element 7, the impedance adjustment element 8 and the distal end of the coaxial cable body 6 with a heat-shrinkage tube 110, and a step of heating the base end aperture 110b of the heat-shrinkage tube 110 to thereby constrict by thermal shrinkage, detachment is prevented by merely heating the heat-shrinkage tube 110 and preparation of the antenna apparatus 101 is facilitated in which the elements overall are supported and protected by the heat-shrinkage tube 110.

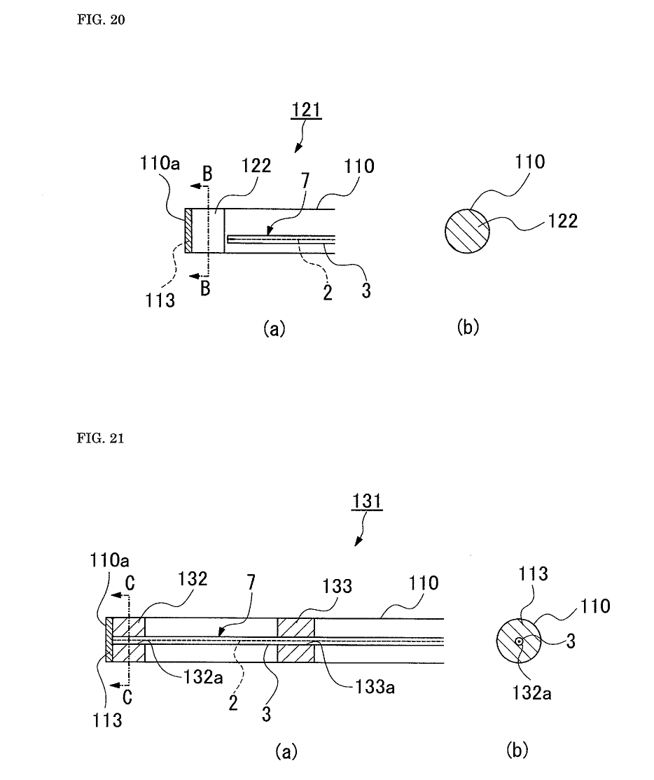

The third to the fifth embodiments of the antenna apparatus according to the present disclosure will be described below with reference to FIG. 20 to FIG. 22. In the description of each embodiment hereafter the same constituent elements as described in the above embodiments are denoted by the same reference numerals and such description will not be repeated.

The point of difference between the second embodiment and the third embodiment is such that, in contrast to the second embodiment in which the distal end aperture 110a of the heat-shrinkage tube 110 is closed and adhered using an adhesive agent 113, in the antenna apparatus 121 according to the third embodiment as shown in FIG. 20, a cylindrical sealing member 122 is fitted to the distal end aperture 110a of the heat-shrinkage tube 110 and the sealing member 122 and the distal end aperture 110a are joined using the adhesive agent 113 to thereby seal the distal end aperture 110a.

The sealing member 122 may be formed for example from a resin, a foam polystyrene, a sponge or the like.

More specifically, when the distal end aperture 110a of the heat-shrinkage tube 110 is adhered using only the adhesive agent 113, there is a risk that the distal end aperture 110a will open due to the elasticity of the thermal-shrinkage tube 110 resulting from a reduction in adhesive strength in high-temperature conditions. However the antenna apparatus 121 according to the third embodiment seals the distal end aperture 110a of the heat-shrinkage tube 110 with a sealing member 122, and therefore prevents the release of the distal end aperture 110a even when the adhesive strength is reduced as a result of the adhesive agent 113.

The point of difference between the third embodiment and the fourth embodiment is such that, in contrast to the third embodiment in which the distal end of the main antenna element 7 is a free end in the heat-shrinkage tube 110, in the antenna apparatus 131 according to the fourth embodiment as shown in FIG. 21, a first through hole 132a is formed in a cylindrical first supporting member (element fixing member) 132 that seals the distal end aperture 110a. The distal end of the main antenna element 7 is inserted into the first through hole 132a, and a cylindrical second support member (element fixing member) 133 forming a second through hole 133a passing through the main antenna element 7 is also provided midway in the thermal-shrinkage tube 110.

There is no particular limitation on the shape of the second supporting member 133 as long as it has a shape enabling fixing to an inner surface of the thermal-shrinkage tube 110. More specifically, the shape of the second supporting member 133 may be for example columnar or spherical.

Since the antenna apparatus 131 according to the fourth embodiment includes the first supporting member 132 and the second supporting member 133 that fix the distal end and the intermediate portion of the main antenna element 7 to an inner surface of the thermal-shrinkage tube 110, production of an abnormal sound resulting from vibration of the main antenna element 7 causing contact with the inner surface of the thermal-shrinkage tube 110 can be prevented. Although both the first supporting member 132 and the second supporting member 133 are used in the present embodiment to support and fix the main antenna element 7, either member may be used to support and fix.

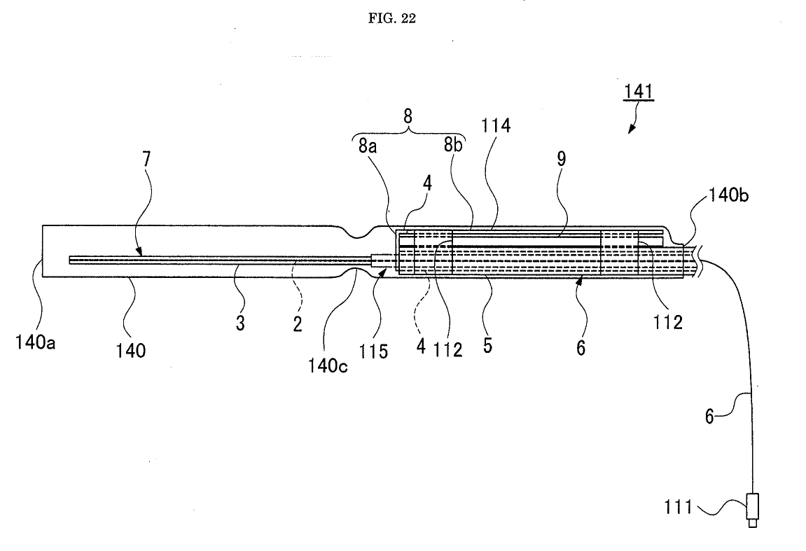

The point of difference between the second embodiment and the fifth embodiment is such that, in contrast to the second embodiment in which the distal end aperture 110a of the heat-shrinkage tube 110 is closed and adhered using an adhesive agent 113, in the antenna apparatus 131 according to the fifth embodiment as shown in FIG. 22, the distal end aperture 140a is not closed, and an intermediate constricted portion 140c that is an intermediate portion of the thermal-shrinkage tube 140 and has a constricted diameter is formed at a position forward of the distal end of the impedance adjustment element 8 and the coaxial cable body 6.

The antenna apparatus 141 according to the fifth embodiment differs from the second embodiment in that the thermal-shrinkage tube 140 is formed from fire-resistant material.

The fire-resistant material forming the thermal-shrinkage tube 140 for example combines a fire-resistant material that contains a halogen element with a fire-resistant material that does not contain a halogen element. In particular, from the point of view of reducing impact on the environment when disposing, the tube is formed from a fire-resistant material combining a fire-resistant material that does not contain a halogen element (non-halogen fire-resistant material).

The intermediate constricted portion 140c is shrunk and formed with a constricted diameter by heating a position forward of the distal end of the impedance adjustment element 8 and the coaxial cable body 6. The formation of the intermediate constricted portion 140c is performed by passing the antenna apparatus main body 115 through the thermal-shrinkage tube 140 and engaging a portion of the spacer 9 and the impedance adjustment element 8 with a base end aperture 140b.

In the antenna apparatus 141 according to the fifth embodiment, since the intermediate constricted portion 140c that is an intermediate portion of the thermal-shrinkage tube 140 and has a constricted diameter is formed at a position forward of the distal end of the impedance adjustment element 8 and the coaxial cable body 6, displacement of the impedance adjustment element 8 and the coaxial cable body 6 is restricted about the distal ends thereof by the intermediate constricted portion 140c and the base end aperture 140b that have a restricted diameter, and therefore detachment and deviation can be prevented.

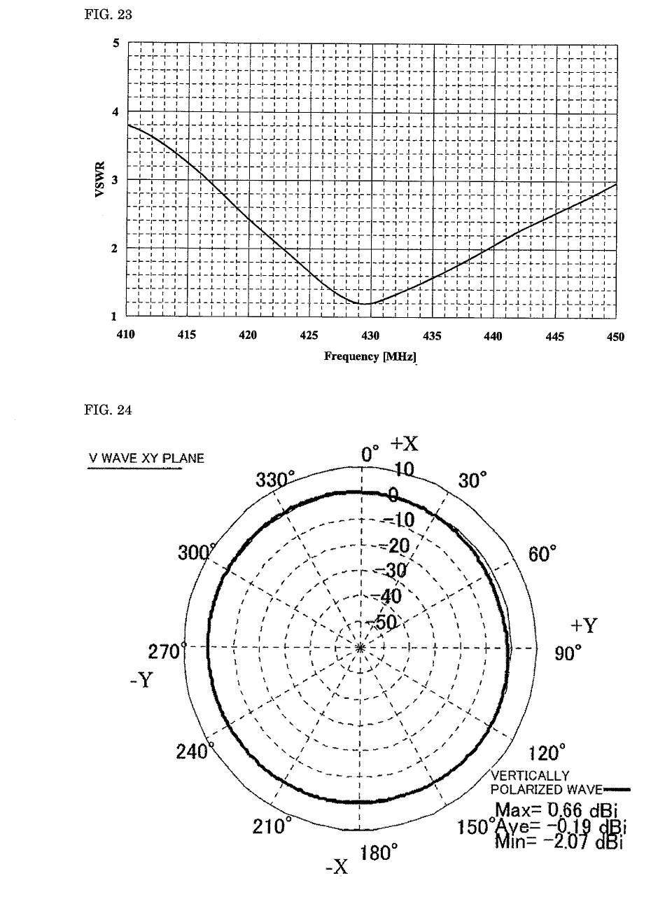

Next, the results of evaluation of actually prepared examples with reference to the embodiments of the antenna apparatus according to the present disclosure will be described in detail making reference to FIG. 23 and FIG. 24.

Firstly, the results of measuring the VSWR (voltage standing wave ratio) performance of the antenna apparatus 101 according to the second embodiment are shown in FIG. 23.

In FIG. 23, although VSWR was tuned to have a minimum in the vicinity of 430 MHz, there was no particular limitation in this regard, and obviously, application is possible by tuning to other frequency bands.

The VSWR performance displayed almost no change in the resonance frequency in a configuration in which the coaxial cable body 6 extended straight (default configuration) or a configuration in which the coaxial cable body 6 was changed into a bent configuration (cable variation configuration). This was due to the fact that the impedance adjustment element 8 acts to cancel impedance or phase shift resulting from reflected waves produced by variation to the coaxial cable body 6.

FIG. 24 shows the radiation pattern of the antenna apparatus 101 according to the second embodiment. This radiation pattern has a vertically (V) polarized wave characteristic in the XY plane when the main antenna element 7 is installed in the Z direction. As shown by the results, a radiation pattern was obtained which displays superior isotropy.

The present disclosure is not limited to the above embodiments, and various modifications may be made within a scope that does not depart from the spirit of the disclosure.

In the above embodiments, although the main antenna element 7 is linear, for example, at least a portion may be formed in a spiral shape, or even compressed. Furthermore although the extension portion 8b of the impedance adjustment element 8 is also linear, it may be compressed by wrapping into a spiral shape onto the coaxial cable body 6 and the spacer 9.

In the first embodiment, as described above, although the core 2 projects together with the first covering dielectric unit 3 to form the main antenna element 7, the main antenna element may be formed by only a projection of the core 2.

Furthermore in the first embodiment, as described above, although the impedance adjustment element 8 and the distal end of the coaxial cable body 6 is covered and fixed by the tube 10, these elements may be fixed using another fixing means. For example, these elements may be fixed using an insulating tube or the like.

For example, in the second to the fifth embodiments, although the connecting lead line was connected to the ground line, the ground line which is a braided line may be bundled and extended singly. Furthermore in the second embodiment and the third embodiment, although the distal end aperture of the thermal-shrinkage tube is closed using an adhesive agent or a sealing member, closure may be effected by using another means. For example, the distal end aperture of the thermal-shrinkage tube may be closed using a stapler.

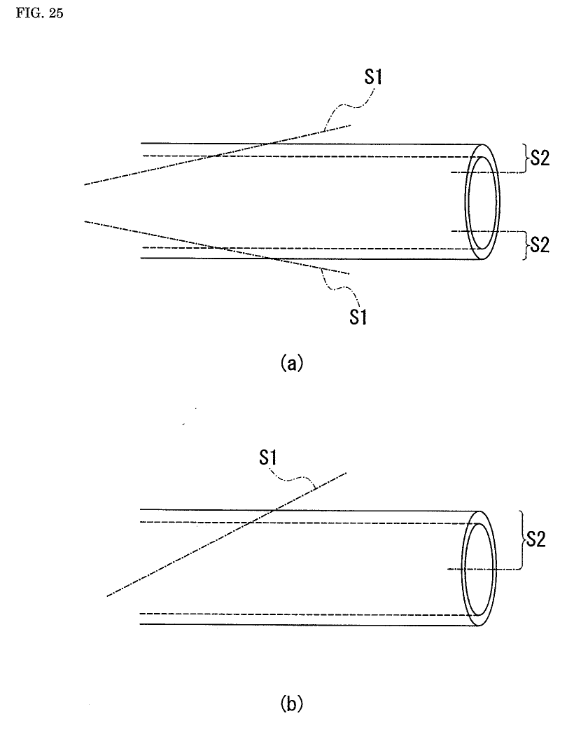

In the second embodiment to the fifth embodiment, as described above, although a thermal-shrinkage tube is used, a tube formed with a material other than a thermal-shrinkage material may be used. In this case, for example, the second shown by the dotted line S1 in the base end aperture of the tube as shown in FIG. 25(a) is folded, fixed with a tube and the second shown by the reference number S2 is folded and constricted to thereby constrict the base end aperture.

Furthermore although the tube supports the main antenna element to extend in a predetermined direction of extension as described above and combines both flexible and rigid properties to enable installation along a mounting position, a tube that is hard and highly rigid, and difficult to bent may be used.

1. An antenna apparatus comprising:
a coaxial cable body configured by covering the peripheral portion of a core forming the power feed line with a first coating dielectric unit, a ground line, and a second coating dielectric unit in that order;
a main antenna element in which the core projects and extends from the distal end of the coaxial cable body; and
an impedance adjustment element in which the ground line projects from the distal end of the coaxial cable body, the impedance adjustment element maintains an orientation extending in a direction that differs from the extension direction of the main antenna element and is fixed to the distal end of the coaxial cable body.

2. The antenna apparatus according to claim 1, wherein the direction of extension of the impedance adjustment element is set to an angle within 90° of the direction of extension of the distal end of the coaxial cable body.

3. The antenna apparatus according to claim 1, wherein the core in combination with the first coating dielectric unit projects and extends from the distal end of the coaxial cable body

4. The antenna apparatus according to claim 2, wherein the impedance adjustment element is folded from the distal end of the coaxial cable body and extends along the coaxial cable body.

5. The antenna apparatus according to claim 4, wherein a spacer is interposed between the impedance adjustment element and the coaxial cable body.

6. The antenna apparatus according to claim 4, wherein the main antenna element, the impedance adjustment element and the distal end of the coaxial cable body are covered with a tube.

7. An antenna apparatus comprising:
a coaxial cable body configured by covering the peripheral portion of a core forming the power feed line with a first coating dielectric unit, a ground line and a second coating dielectric unit in that order;
a main antenna element in which the core projects and extends from the distal end of the coaxial cable body;
an impedance adjustment element in which the ground line or a connection lead line connected to the ground line is folded from the distal tip of the coaxial cable body, and the impedance adjustment element maintains an orientation extending from the distal tip of the coaxial cable body along the coaxial cable body, and is fixed to the distal end of the coaxial cable body; and
a tube that covers the main antenna element, the impedance adjustment element, and the distal end of the coaxial cable body, and that at least constricts the base end aperture.

8. The antenna apparatus according to claim 7, wherein the tube is a thermal-shrinkage tube, and the base end aperture is constricted by thermal shrinkage.

9. The antenna apparatus according to claim 7, wherein the core in combination with the first coating dielectric unit projects and extends from the distal end of the coaxial cable body;

10. The antenna apparatus according to claim 7, wherein the distal end aperture is closed.

11. The antenna apparatus according to claim 7, wherein an intermediate constricted portion is configured from an intermediate portion of the tube and has a restricted diameter at a position forward of the distal end of the coaxial cable body and the impedance adjustment element.

12. The antenna apparatus according to claim 7, wherein at least one element fixing member is provided in the tube, and fixes at least one of the distal end and the intermediate portion of the main antenna element to an inner face of the tube.

13. The antenna apparatus according to claim 7, wherein the tube of the antenna apparatus is formed from a transparent material.

14. The antenna apparatus according to claim 7, wherein the tube of the antenna apparatus is formed from a semi-transparent material.

15. The antenna apparatus according to claim 7, wherein the tube of the antenna apparatus is formed from a fire-resistant material.

16. The antenna apparatus according to claim 7, wherein the tube of the antenna apparatus has a flattened sectional shape.

17. The antenna apparatus according to claim 7, wherein a high-frequency connector is connected to the base end of the coaxial cable body.

18. A method of manufacturing an antenna apparatus including the steps of:
preparing an antenna apparatus main body including a coaxial cable body configured by covering the peripheral portion of a core forming the power feed line with a first coating dielectric unit, a ground line and a second coating dielectric unit in that order, a main antenna element in which the core projects and extends from the distal end of the coaxial cable body, and an impedance adjustment element in which the ground line or a connection lead line connected to the ground line is folded from the distal tip of the coaxial cable body, the impedance adjustment element maintaining an orientation extending from the distal tip of the coaxial cable body along the coaxial cable body and fixed to the distal end of the coaxial cable body;
covering the main antenna element, the impedance adjustment element and the distal end of the coaxial cable body with a heat-shrinkage tube; and
heating to thereby shrink and contract the base end aperture of the heat-shrinkage tube.

19. The method of manufacturing an antenna apparatus according to claim 18, wherein the core in combination with the first coating dielectric unit projects and extends from the distal end of the coaxial cable body.
